(19) United States
(12) Patent Application Publication
(10) Pub. No.: US 2010/0223757 A1
(43) Pub. Date: Sep. 9, 2010

(54) HINGE

(75) Inventor: WEN-BIN SHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/485,012

(22) Filed: Jun. 15, 2009

(30) Foreign Application Priority Data
Mar. 3, 2009 (CN) 200920301019.4

(51) Int. Cl. E05D 11/10

(52) U.S. Cl. 16/343; 16/319

(57) ABSTRACT

A hinge includes a first connecting member, a shaft fixed to the first connecting member, a second connecting member rotatably mounted to the shaft, and a positioning member fixed to the shaft. The shaft includes a resisting portion, and a positioning protrusion protrudes out from the resisting portion. The second connecting member is sandwiched between the resisting portion and the positioning member. A first resisting post and a second resisting post extend from opposite sides of the second connecting member. The positioning member includes a withstanding surface. During rotation of the second connecting member relative to the first connecting member, the first resisting post resists against the withstanding surface, and simultaneously, the second resisting post resists against an end of the positioning protrusion.

### BACKGROUND

1. Technical Field

The disclosure relates to a hinge.

2. Description of Related Art

A collapsible device, such as a notebook computer, or a clamshell mobile phone, generally including a main body and a cover often uses a hinge to interconnect the main body and the cover. The hinge allows the cover to be rotatable with respect to the main body, and to be folded with the main body for saving space.

A hinge normally includes a first element and a second element fixed to the main body and the cover of the collapsible device, respectively. The first and second elements are rotatable relative to and in friction engagement with each other for maintaining the cover at any angle with respect to the main body. During rotation, the cover can maintain at any angle with respect to the main body by friction between the first and second elements. However, the first and second elements are not durable after frequent usage and due to wear and tear, resulting in preventing the cover from being able to stay at certain desirable positions. When one of the first and second elements is worn out, the cover cannot maintain stability at certain desirable positions with respect to the main body, which creates a quite inconvenience for users. Even worse, the cover can be over-rotated by enough force resulting in damaging the hinge.

### BRIEF DESCRIPTION OF THE DRAWINGS

FIG. 1 is an exploded, isometric view of an exemplary embodiment of a hinge, the hinge including a first connecting member and a second connecting member.

FIG. 2 is an inverted view of the hinge of FIG. 1.

FIG. 3 is an assembled, isometric view of the hinge of FIG. 1.

FIG. 4 is similar to FIG. 3, but showing the second connecting member being rotated an angle relative to the first connecting member.

FIG. 5 is similar to FIG. 4, but viewed from another perspective.

### DETAILED DESCRIPTION

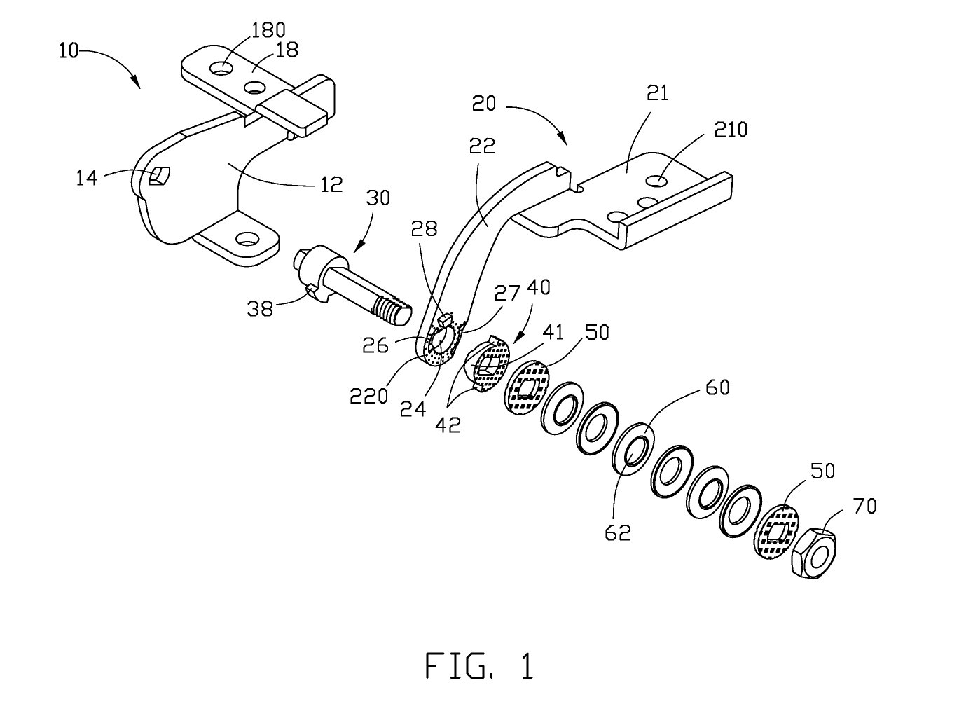

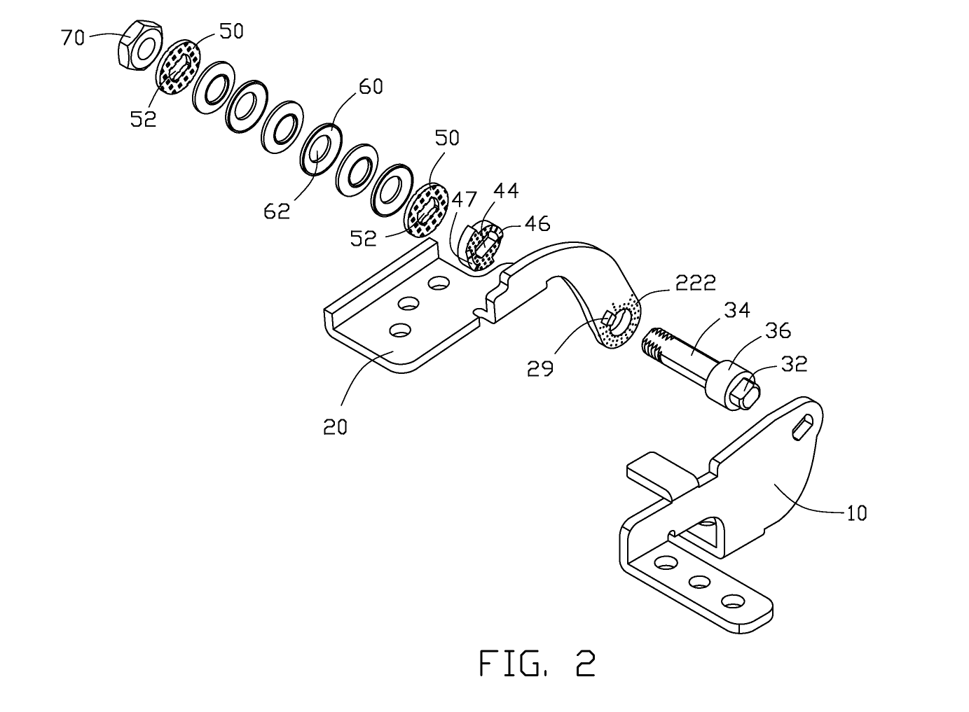

Referring to FIGS. 1 and 2, an exemplary embodiment of a hinge includes a first connecting member 10, a second connecting member 20, a shaft 30, a positioning member 40, two friction members 50, a plurality of elastic rings 60, and a fastener 70. In the embodiment, the fastener 70 is a nut.

The shaft 30 includes a fixing portion 32, a shaft body 34, and a resisting portion 36 between the fixing portion 32 and the shaft body 34. The fixing portion 32 has a double-D shaped cross-section for fixing the first connecting member 10. The shaft body 34 has a double-D shaped cross-section, and forms a threaded portion (not labeled) on a circumference of a distal end of the shaft body 34, for engaging in the fastener 70. A positioning protrusion 38 protrudes out from a circumference of the resisting portion 36, neighboring to the shaft body 34.

The first connecting member 10 includes a connecting portion 18 defining a plurality of fixing holes 180, and a fixing board 12 extending from an end of the connecting portion 18. The fixing board 12 defines a fixing hole 14 having a double-D shape, corresponding to the fixing portion 32 of the shaft 30, for fixing the shaft 30.

The second connecting member 20 includes a fixing body 21 defining a plurality of fixing holes 210, and a curved pivoting portion 22 extending from an end of the fixing body 21. The pivoting portion 22 includes a first side 220 and a second side 222 opposite to the first side 220. The pivoting portion 22 defines a through hole 24 passing through the first and second sides 220, 222 for allowing the shaft body 34 to rotatably pass therethrough. A first depressed portion 26 and a second depressed portion 27 are defined in the first side 220, opposite to each other across the through hole 24. The first depressed portion 26 extends along a cambered edge of the through hole 24, and the second depressed portion 27 extends along an edge of the pivoting portion 22, adjacent to the through hole 24. A first resisting post 28 extends from the first side 220, between the first and second depressed portions 26, 27. A second resisting post 29 extends from the second side 222, facing the first connecting member 10.

The positioning member 40 is generally washer-shaped, and defines an arcuate cutout 41 along a circumference of the positioning member 40, with forming two withstanding surfaces 42 at opposite ends of the cutout 41. The positioning member 40 defines a matching hole 44 having a double-D shape, corresponding to the shaft body 34 of the shaft 30, for unrotatably fitting about the shaft body 34 of the shaft 30. A first raised portion 46 and a second raised portion 47 protrude out from one side of the positioning member 40, facing the first side 220 of the pivoting portion 22 of the second connecting member 20, corresponding to the first depressed portion 26 and second depressed portion 27, respectively. Therefore, the first and second raised portions 46, 47 are correspondingly engaged in the first and second depressed portion 26, 27.

Each friction member 50 defines a double-D shaped fixing hole 52, for unrotatably receiving the shaft body 34 of the shaft 30.

Each elastic ring 60 provides elasticity along an axial direction of the shaft 30, to tighten the first connecting member 10, the second connecting member 20, the positioning member 40, and one of the friction members 50. Each elastic ring 60 defines a round through hole 62, allowing the shaft body 34 of the shaft 30 to rotatably pass therethrough.

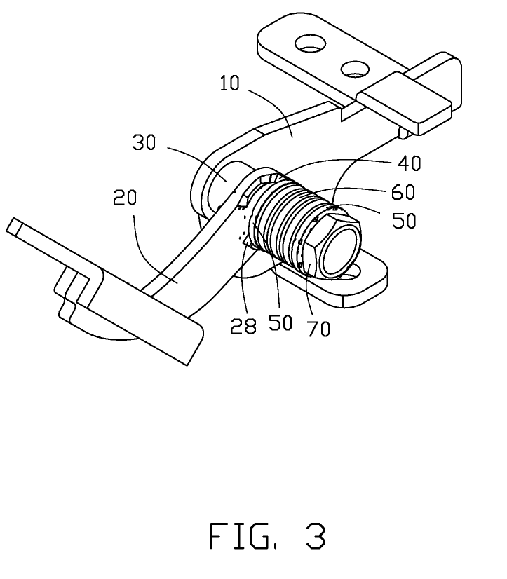

Referring to FIG. 3, in assembly, the fixing portion 32 of the shaft 30 is fixedly received in the fixing hole 14 of the first connecting member 10, therefore, the shaft 30 is fixed to the first connecting member 10. The shaft body 34 of the shaft 30 is passed through the through hole 24 of the second connecting member 20, the matching hole 44 of the positioning member 40, the fixing hole 52 of one of the friction members 50, the through holes 62 of the plurality of elastic rings 65, and the fixing hole 52 of the other friction member 50 one by one in that order, with the distal end of the shaft body 34 engaging in the fastener 90 for preventing the first connecting member 10, the second connecting member 20, the positioning member 40, the plurality of elastic rings 60, and the friction members 50 from disengaging from the shaft 30.

In the aforementioned assembly, the first and second sides 220, 222 of the first connecting member 20 resist against the positioning member 40 and the resisting portion 36 of the shaft 30, respectively, with the first and second raised portions 46, 47 of the positioning member 40 correspondingly engaging in the first and second depressed portions 26, 27 of the second connecting member 20. Therefore, the first resisting post 28 sidely resists against the circumference of the positioning member 40 in the cutout 41, and the second resisting post 29 sidely resists against the circumference of the resisting portion 36 of the shaft 30.

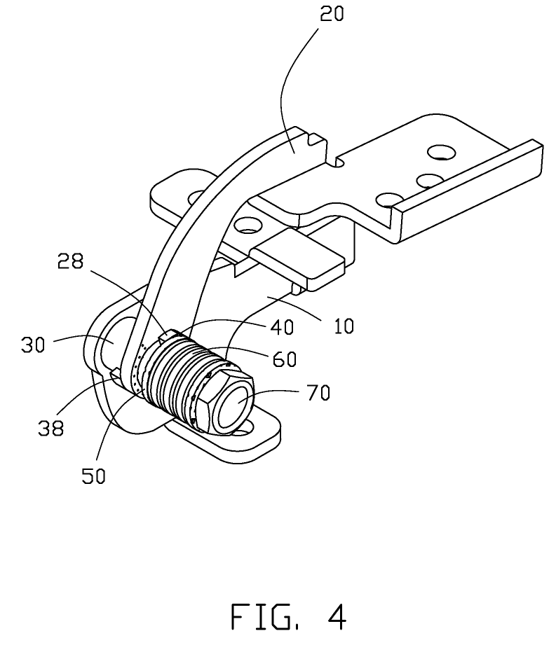

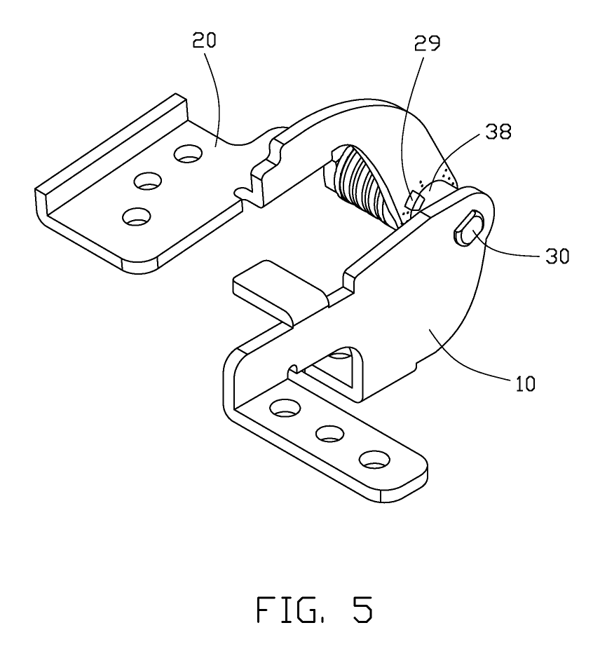

Referring to FIGS. 4 and 5, in use, the first connecting member 10 is fixed to one of a cover and a base of a collapsible device (not shown), via the plurality of fixing holes 180, and the second connecting member 20 is fixed to the other one of the cover and the base of the collapsible device, via the plurality of fixing holes 210. Therefore, during rotation of the cover relative to the base, the second connecting member 20 rotates relative to the first connecting member 10. As a result, the first and second raised portions 46, 47 move onto the first side 220 of the second connecting member 20 or into the first and second depressed portions 26, 27. In the meanwhile, the first resisting post 28 of the second connecting member 20 moves along the circumference of the positioning member 40 in the cutout 41, and the second resisting post 29 of the second connecting member moves along the circumference of the resisting portion 36 of the shaft 30. When one of the withstanding surfaces 42 of the positioning member 40 resists against the first resisting post 28 of the second connecting member 20, synchronously, the second resisting post 29 resists against one end of the positioning protrusion 38. Therefore, the second connecting member 20 cannot be rotated further relative to the first connecting member 10. Consequently, the cover is stably maintained at a certain desirable position with respect to the base resulting preventing the cover from over-rotating.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

What is claimed is:

1. A hinge comprising:
a first connecting member;
a shaft fixed to the first connecting member, and comprising a resisting portion, a positioning protrusion protruding out from the resisting portion;
a second connecting member rotatably mounted to the shaft, a first resisting post and a second resisting post extending from opposite sides of the second connecting member; and
a positioning member fixed to the shaft, and comprising at least one withstanding surface;
wherein the second connecting member is sandwiched between the resisting portion of the shaft and the positioning member, during rotation of the second connecting member relative to the first connecting member, the first resisting post resists against the at least one withstanding surface, and simultaneously, the second resisting post resists against an end of the positioning protrusion.

2. The hinge of claim 1, wherein the positioning member defines an arcuate cutout along a circumference of the positioning member, the at least one withstanding surface comprises two withstanding surfaces forming at opposite ends of the cutout.

3. The hinge of claim 1, wherein the shaft further comprises a shaft body extending from the resisting portion, the second connecting member defines a through hole for allowing the shaft body to pass therethough.

4. The hinge of claim 3, wherein the second connecting member defines a first depressed portion and a second depressed portion opposite to each other across the through hole, a first raised portion and a second raised portion protrude out from the positioning member to engage in the first and second depressed portions, respectively.

5. The hinge of claim 4, wherein the first depressed portion extends along an edge of the through hole, and the second depressed portion extends along an edge of the second connecting member.

6. A hinge comprising:
a first connecting member;
a shaft fixed to the first connecting member, and comprising a shaft body;
a second connecting member rotatably mounted to the shaft body, and comprising a first side defining a first depressed portion and a second depressed; a first resisting post extending from the first side of the second connecting member;
a positioning member fixed to the shaft body, and comprising at least one withstanding surface; a first raised portion and a second raised portion protruding out from the positioning member correspondingly engaged in the first and second depressed portions;
at least one elastic ring rotatably mounted to the shaft body; and
a fastener fixed to a distal end of the shaft body to prevent the second connecting member, the positioning member, and the at least one elastic ring from disengaging from the shaft body;
wherein during rotation of the second connecting member relative to the first connecting member, the first and second raised portions slidably move out from or into the first and second depressed portions, and the first resisting post is operable to resist against the at least one withstanding surface.

7. The hinge of claim 6, wherein the positioning member defines an arcuate cutout along a circumference of the positioning member, the at least one withstanding surface comprises two withstanding surfaces forming at opposite ends of the cutout.

8. The hinge of claim 6, wherein the second connecting member further comprises a second side opposite to the first side, and the second connecting member defines a through hole through the first and second sides for allowing the shaft body to pass therethrough.

9. The hinge of claim 8, wherein the first and second depressed portions are opposite to each other across the through hole, the first depressed portion extends along an edge of the through hole, and the second depressed portion extends along an edge of the second connecting member.

10. The hinge of claim 8, wherein the shaft further comprises a resisting portion resisting against the second side of the second connecting member, the shaft body extends from the resisting portion.

11. The hinge of claim 10, wherein a positioning protrusion protrudes out from a circumference of the resisting portion, a second resisting post extends from the second side of the second connecting member for resisting against the positioning protrusion.

12. The hinge of claim 6, further comprising two friction members fixed to the shaft body, beside opposite sides of the at least one elastic ring, wherein one of the friction members abuts against the positioning member, and the other friction member resists against the fastener.
